(19) United States
(12) Patent Application Publication
(10) Pub. No.: US 2014/0229350 A1
(43) Pub. Date: Aug. 14, 2014

(54) Method for creating and auctioning options on real estate properties to enable risk managed future transactions and to add liquidity in real estate market

(71) Applicant: Dongshui Zeng, Yorba Linda, CA (US)

(72) Inventor: Dongshui Zeng, Yorba Linda, CA (US)

(73) Assignee: Dongshul Zeng, Yorba Linda, CA (US)

(21) Appl. No.: 13/765,690

(22) Filed: Feb. 12, 2013

(51) Int. Cl. G06Q 40/04

(52) U.S. Cl. CPC G06Q 40/04
USPC 705/37

(57) ABSTRACT

Aspects of the present disclosure provides a method to enable the selling and buying of a property at a future time for a pre-agreed price. In accordance with aspects of the disclosure, a series of call options and put options on a property are created and transacted between a seller and a buyer. The call option defines the buyer's right to buy and seller's obligation to sell the underline property. The put option defines the seller's right to sell and buyer's obligation to buy the underline property. Property sellers, buyers, and investors, thus can plan guaranteed real estate transactions in the future times, can hedge against property price fluctuations, can save real estate transaction costs; and can manage real estate investment needs with measured and known risks therefore promoting more transactions and adding liquidity to the real estate market.

### BACKGROUND OF THE INVENTION

Property sellers and buyers are powerless in dealing with the real estate market fluctuations as one may recall a market run up till 2007 and then freefalling by 2008. Using currently available tools and systems, people buy and sell homes for prices under current market conditions. Buyers and sellers may be watching a price skyrocketing or witnessing a price freefalling, but cannot or will not take any action due to uncertainty and potential risks. Often people can only wish that they have done something many months or many years back in times. Lack of innovation in real estate transaction gives little or no means for home sellers and buyers to manage risks, and to lock in future selling prices month and years ahead of times, therefore we have to live with the real estate illiquidity nature. Another major hurdle in real estate transaction is the average 6% of home selling price spent as commission to pay real estate agents in addition to other costs relating home appraisal, underwriting, escrow, etc. For the reason of cost alone, real estate illiquidity is further severely exasperated.

There is a need for a method that permits a cost effective real estate transaction with guaranteed buys and sells along with guaranteed transaction prices, and further enables an attractive and risk managed investment vehicle, and further creates desires and willingness for home sellers, buyers and investors alike to participate much more frequent real estate transactions, therefore adding liquidity to the real estate market.

### SUMMARY OF THE INVENTION

A seller wishes to sell a property at a future time for a pre-agreed future selling price can sell a call option or buy a put option on the underline property; a buyer wishes to buy a property in the future time for a pre-agreed future selling price can purchase a call option or sell a put option on the underline property. Aspects of the present disclosure provides a method to enable the selling and buying of a property at a future time for a pre-agreed future selling price through an option auction event; the future transaction is defined and guaranteed by an option agreement along with a non-refundable option premium. The future purchase price and option premium price in aspects of the disclosure are determined as a result of the option auction event.

In accordance with aspects of the disclosure is a method to create a series of call options on a property for a seller to sell one, preferably the highest priced call option to a property buyer, and/or to create a series of put options on the said property for the property seller to buy one, preferably the lowest priced put option from a property buyer. The call option defines the property buyer's right (but not obligation) to buy the underline property and also defines the seller's obligation to sell if the buyer exercises the right to buy. The put option defines the seller's right (but not obligation) to sell the underline property and also defines buyer's obligation to buy if the seller exercises the right to sell. Both the call option and the put option are legally binding agreement each coupled with a non-refundable option premium paid by the buyer to the seller in a call option and by the seller to the buyer in a put option.

A property seller may choose to sell a call option, or buy a put option, or the combination of both, the call option buyer and put option seller can be the same or different property buyer. Property sellers, buyers, potential buyers and investors, thus can plan guaranteed real estate transactions in the future times, can hedge against property price fluctuations and risks, can save real estate transaction costs; and can manage real estate investment needs with measured and known risks therefore promoting more transactions and adding liquidity to the real estate market.

### BRIEF DESCRIPTION OF THE DRAWINGS

The follow drawings are helpful in explaining aspects of this disclosure.

FIG. 1 is a diagram showing aspects of hardware systems and parties that may be involved in creating a series of call options and a series of put options on a real property, and in auctioning of call options, or put options or both.

FIG. 2 is an example of a listed property for auction and a series of call options created and displayed in a call option map (COMAP) for buyers to bid on.

FIG. 3 is an example of a listed property for auction and a series of call options created and displayed in a call option map (COMAP) for buyers to bid on with a fast acceleration of bidding prices.

FIG. 4 is an example of a listed property for auction and a series of call options created and displayed in a call option map (COMAP) for buyers to bid on with a medium acceleration of bidding prices.

FIG. 5 is an example of a listed property for auction and a series of put options created and displayed in a put option map (POMAP) for buyers to bid on.

FIG. 6 is an example of a listed property for auction and a series of put options created and displayed in a put option map (POMAP) for buyers to bid on with a fast acceleration of bidding prices.

FIG. 7 is an example of a listed property for auction and a series of put options created and displayed in a put option map (POMAP) for buyers to bid on with a medium acceleration of bidding prices.

FIG. 8 is an example of a listed property for auction and a series of call options and a series of put options created and displayed in an integrated call and put options map (CPMAP) for buyers to bid on.

FIG. 9 is an example of benefits that a seller plans and executes an option agreement in 2012 to guarantee a sale of the property in 2015 with a guaranteed selling price range; further the benefits of a buyer plans and executes an option agreement in 2012 to guarantee a purchase of the property in 2015 with a guaranteed purchase price range.

### DETAILED DESCRIPTION OF THE INVENTION

To simplify the description of this invention and to put clarity to the meaning of words and phrases relating to the description of this invention, the following glossaries are assembled and are used throughout the application:
1. Property: Refers to a home, property, real property, real estate property, residential property, and commercial property. These terms are used interchangeably, and are inclusive of their plural forms when referring to this disclosure, and may further refers to other valuable assets, such as airplanes, ships, boats, collectibles, cars, commercial buildings, restaurants, manufacture facilities, jewelries, diamonds, precious metals, rare earth metals, financial instruments, such as bonds, notes, stocks and options etc.
2. Property seller and potential property seller (collectively Seller): A party who sells or intends to sell a property at a future time for a known price by selling a call option on a property, or by purchasing a put option on a property, or the combination of both. A seller can be an owner of a property, can be a person, an organization, an investor, a company, and a speculator, etc. who has the right to sell a property
3. Property buyer and potential property buyer (collectively Buyer): A party who buys or intends to buy a property at a future time for a known price by purchasing a call option on a property, or by selling a put option on a property, or the combination of both. A buyer can be a person, an organization, an investor, a company, and a speculator, etc.
4. Auction website: Refers to a website that is hosted on a computer server, the website is part of the front end of the auction system, and the computer server, part of the back end of the auction system. The auction website, website, auction computer server, computer server, server and auction server are used interchangeably throughout this application; all refers to aspects of the disclosed auction system.
5. ALD: Auction Listing Date: A date when a property seller activates an auction of a property
6. AED: Auction Ending Date: A date when an auction ends or is closed, typically defined by ending at 11:59:59 pm of an auction ending date.
7. Auction period or a period of auction: A period of time between the ALD and the AED, for example 30 days, 60 days and 90 days, etc.
8. FSD, FPD, FTD, ECD and OED (collectively refers to as a Future Date, FD): They are used interchangeably throughout this application, such that a property Future Selling Date (FSD) is used from the seller's point of view, a Future Purchase Date (FPD) from the buyer's point of view, a Future Transaction Date (FTD) from a transaction point of view, an Escrow Closing Date (ECD) from escrow point of view, and an Option Expiration Date (EOD) in an option term.
9. TTS: Time Till Sell refers to a period of time between the AED and the planned future selling date or the Option Expiration Date (OED). TTS can be 3 months or longer, preferably 6 months or longer, and more preferably 9 months or longer. TTS can be as long as 3 years, 5 years, 10 years, 15 years, or 30 years or even longer.
10. CHV: An estimated Current Home Value. A CHV is available from open sources such as MLS, Realtor.com, Zillow.com, Trulia.com, and Redfin.com or from a licensed realtor or even from the opinion of the property seller. As it is later further defined, a CHV is used for calculation of a series of bidding prices comprising of future purchase prices or strike prices and option premium prices. It is not necessary that the CHV be accurately reflective of the property's real current value.
11. ACR: An estimated Annual Change Rate in property value. An ACR can be a positive percentage or a negative percentage number, referring to a hypothetic annual appreciation or annual depreciation rate of a property's value which may differ from one region to another and from one type of property to another type.
12. TCR: A Total Change Rate refers to the total price change in percentage from AED to OED, or COED in a call option agreement, POED in a put option agreement.
13. TCV: A Total Change Value refers to the total change value in dollars from AED to OED.
14. Call option: A legal binding option agreement or contract that a property buyer, who pays a property seller a call option premium, has the right but not the obligation to purchase the sellers' property at a future time for a known price; and for the property seller, in exchange of receiving buyer's call option premium, is obligated to sell the property to the buyer at the defined future time if, and only if, the buyer exercises the right to buy. A buyer's call option right has a value that may change as a function of the underline property value changes and as a function of the time left on the life of a call option. A call option has an expiration date and the call option becomes worthless after it expires unless buyer and seller extend the life of the call option with a new expiration date. A call option right in this invention, upon won by the buyer, can be further traded through auction or direct sale channels before it expires, therefore resulting in a transfer of a call option right ownership.
15. Put option: A legal binding option agreement or contract that a property seller, who pays a property buyer a put option premium, has the right but not the obligation to sell the underline property to the buyer at a future time for a known price; for the property buyer, in exchange of receiving seller's put option premium, is obligated to buy the property from the seller at the future time if, and only if, the property seller exercises the right to sell. A buyer's put option obligation has a value that may change as a function of the underline property value changes and as a function of the time left on the life of a put option. A put option has an expiration date and the put option becomes worthless after it expires unless buyer and seller extend the life of the put option with a new expiration date. The buyer's put obligation can be traded via auction or direct sale before it expires, therefore resulting in a transfer of the put obligation to a new property buyer.
16. Spread Option: A combination of a call option and a put option on a property. A property seller can sell a call option to a property buyer-1 and also buys a put option from a property buyer-2 for seller's underline property; in this case, the seller effectively enters into a spread option contract with two buyers. If the buyer-1 and buyer-2 is the same property buyer, then the property buyer effectively enters into a spread option with the property seller. Seller enters a spread option on the same underline property, buyer may enter multiple call option agreements and multiple put option agreement with many sellers as long as financially capable.
17. COED, POED and OED: A Call Option Expiration Date (COED) may be the same as date as a Put Option Expiration Date (POED) for one specific property on auction, in this case an Option Expiration Date (OED) would be used to describe the option expiration date of both call and put options.
18. SP: A property's Strike Price. In a series of call options and a series of put options created on a property, there are a series of strike price levels created for buyers to bid on.
19. WSP: The Winning Strike Price (WSP) is the highest strike price sold in an auction; it becomes the pre-agreed future purchase price of a real property. It is determined by the auction winner as a result of either a call option auction or a put option auction.
20. SPIR: A Strike Price Incremental Rate. A SPIR is the incremental percentage rate between one level strike price and the next level strike price, e.g., 5%.
21. COR: Refers to a Call Option Right. A COR is a buyer's right to purchase a property at a pre-determined future time for a pre-agreed future selling price.
22. COO: Refers to a Call Option Obligation. A COO is a seller's obligation to sell a property at a pre-determined future time for a pre-agreed future selling price.
23. POR: Refers to a Put Option Right. A POR is a seller's right to sell a property at a pre-determined future time for a pre-agreed future selling price.
24. POO: Refers to a Put Option Obligation. A POO is a buyer's obligation to buy a property at a pre-determined future time for a pre-agreed future selling price
25. COP: A Call Option Price refers to a call option premium price created on a property under certain SP level. A series COPs are created under each SP level for buyers to bid on.
26. COPIR: A Call Option Price Increment Rate refers to the incremental percentage rate between one level call option price and the next level call option price, e.g., 10%.
27. WCOP: The Winning Call Option Price is the maximum call option premium a winning buyer is willing to pay to the property seller in order to acquire COR to purchase the property on the COED for the WSP. WCOP is determined by the auction winner as a result of a call option auction event.
28. POP: A Put Option Price refers to a put option premium price created on a property under certain SP level. A series of POPs are created under each SP level for buyers to bid on.
29. POPIR: A Put Option Price Increment Rate refers to the incremental percentage rate between one level put option price and the next level put option price, e.g., 10%.
30. WPOP: The Winning Put Option Price is the minimum put option premium a winning buyer is willing to take from the property seller in exchange of property buyer's obligation to buy the seller's property on the POED for the WSP. WPOP is determined by the auction winner as a result of a put option auction event.
31. COMAP: A Call Option Map displaying the call options available for property buyers to bid on in an auction event.
32. POMAP: A Put Option Map displaying the put options available for property buyers to bid on in an auction event.
33. CPMAP: A Call and Put Option Map displaying the call options and put options available for property buyers to bid on in an auction event.
34. DOP: The Delta Option Price in a CPMAP auction is defined as DOP=COP−POP. DOP is a net option premium a property buyer needs to pay to the property seller in exchange of a buyer's right to buy for a SP, and buyer's obligation to buy at same or different SP. DOP could also be a negative number which means the seller needs to pay a buyer in order to assign property right and obligation to both the seller and the buyer.
35. WDOP: The Winning Delta Option Price is the final winning DOP defined by WDOP=WCOP−WPOP. WDOP is the net of maximum COP less the minimum POP determined in a spread option auction event.
36. CORP: A Call Option Right Price. The buyer's COR to purchase a property can be further traded through another auction or via a direct sales channel; due to market conditions and real estate value fluctuations, the buyer's COR may worth more or less amount than or the same amount as WCOP originally paid by the buyer to a property seller.
37. POOP: A Put Option Obligation Price. The buyer's POO to buy a property can be further traded through another auction or via a direct sales channel; due to market conditions and real estate value fluctuations, the POO may worth more or less amount than or the same amount as WPOP originally received by the property buyer from a property seller.
38. CRPO: A composite of Call Option Right and a Put Option Obligation in a spread option. In a spread option, property buyer has a COR to buy because buyer paid a WCOP to the property seller in a call option part of the spread option; property buyer also has a POO to buy because buyer received a WPOP from the seller in a put option part of the spread option.
39. SOTP: A Spread Option Transfer Price. A property buyer paid a WDOP=WCOP−WPOP and acquired the composite of Call Option Right and a Put Option Obligation (CRPO) in a spread option. This CRPO is tradable for a price of spread option transfer price (SOTP).
40. WAB: A Winning Auction Buyer. A property buyer bid and won a property's call option auction, or property's put option auction or property's spread option auction; a WAB will pay a WCOP to a property seller and in exchange for a COR to purchase the underline property; A WAB will receive a WPOP from a property seller in exchange of an obligation to buy the underline property; and a WAB will pay a WDOP to a seller in exchange of the COR and POO in a spread option.
41. New Property Buyer: A new property buyer in accordance with the aspects of this disclosure refers to property buyers who buy from a WAB after WAB has won and has posted the won COR and POO for auction and for sale.

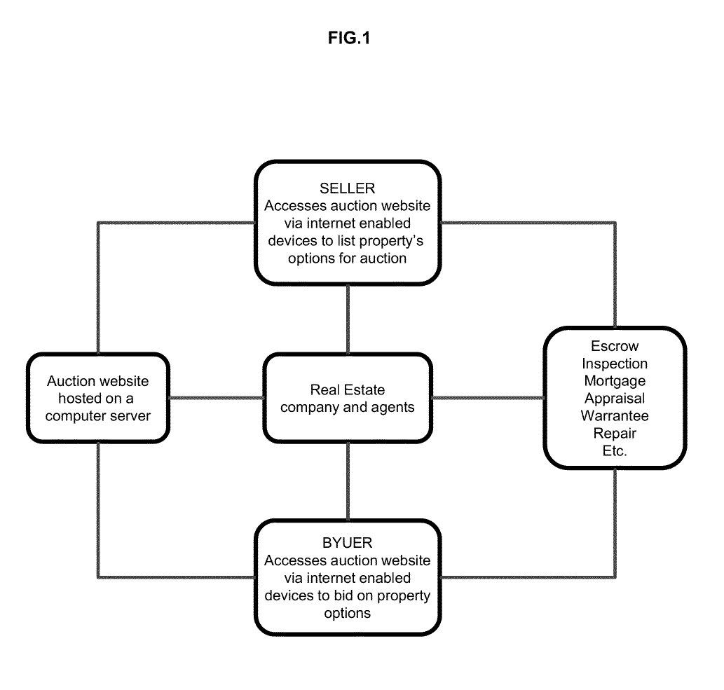

In accordance with various aspects of this disclosure, referring to FIG. 1 is a diagram showing aspects of hardware systems and parties that may be involved in creating a series of call options and a series of put options on a real property, and in auctioning of the said options in an auction environment. Aspects of the disclosed method are performed on an auction website that is hosted on a computer server with hard drivers, memories, displays and all peripherals to function properly. The website on its server is programmed to perform various algorithm and mathematic calculations. Buyers, sellers, administrator of the website or website operator(s) can sign up and then later can log in to perform various functions. On the server that hosts the website, data such as names, addresses, contact numbers, email address, login user names, and passwords, etc. associated with sellers and buyers are stored; data related to real estate properties such as property addresses and features as input by sellers or realtors or acquired from other data banks or sources are stored. Data can be added; the stored data can be edited, retrieved and used in full and in part by sellers, buyers, website operators and website owners. Any and all personnel data are used in compliance with federal and state laws and regulations. Website on the server is configured to handle all sorts of algorithms and mathematic calculations based on the instructions given by website operators, sellers and buyers who use internet enabled devices that connect to monitors, keyboards, and mice or internet enabled devices equipped with touch screen technologies to interface with the website. Real estate companies and agents may be arranged by website operators, buyers and sellers to provide related services, such as coordinating buyers to tour the interested properties, and to provide other services especially when an option is exercised for a buyer to purchase or for a seller to sell a property.

Call Option—A property buyer pays a seller a call option premium in exchange of 1) a buyer's right to purchase the property and 2) a seller's obligation to sell the underline property if buyer exercises the call option right to buy

A property has a value that may change as a result of market conditions influenced by many factors such as supply demand relationship, government policy, interest rate, economic conditions, and lending policies, etc. A property can be treated as an underline security on which a series of call options can be created. However, for each property, one and only one such call option can be sold or owned by another party since there is only one underline property to fulfill an obligation in the event a sold call option is exercised. In accordance with aspects of the disclosure, a method is illustrated to create a series of call options on a property with a seller defined COED which is the future time a seller plan to sell the underline property. Once the series of call options are created on an underline property, they are set up for auction for a period of time (e.g., 30 days, or 60 days) in order to sell one, preferably the most valuable call option. At the end of the auction, the property buyer who wins the call option auction enters a call option agreement with the property seller. The call option agreement is a legally binding agreement that specifies and guarantees a buyer's right to purchase from the seller the underline property on COED for a cost of the wining strike price (WSP); and the property seller, in exchange of receiving winning call option premium (WCOP) paid by the wining buyer, is obligated to sell the underline property to the winning buyer if and only if the winning buyer decides to exercise the right to purchase. Both the WSP and WCOP are determined as a result of the auction event. After having won the call option, the winning buyer can exercise the option to enter into a purchase agreement with the seller and to open escrow to purchase the property according to the option agreement. Alternatively, the winning buyer can set up another auction or by direct sales channel to sell the call option right (COR) for the amount of call option right price (CORP) before COED. This resale process can happen many times before the COED understanding that the CORP from each transaction may vary due to real estate market conditions and due to time left till the COED, also known as the time value of the call option.

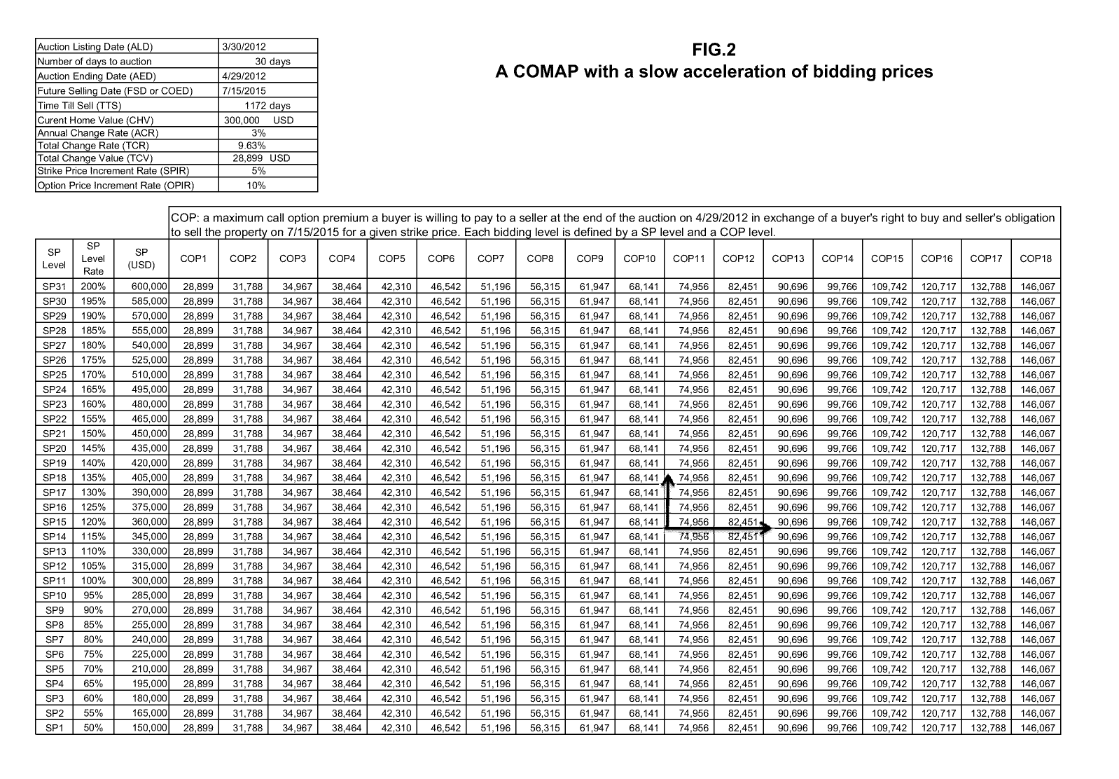

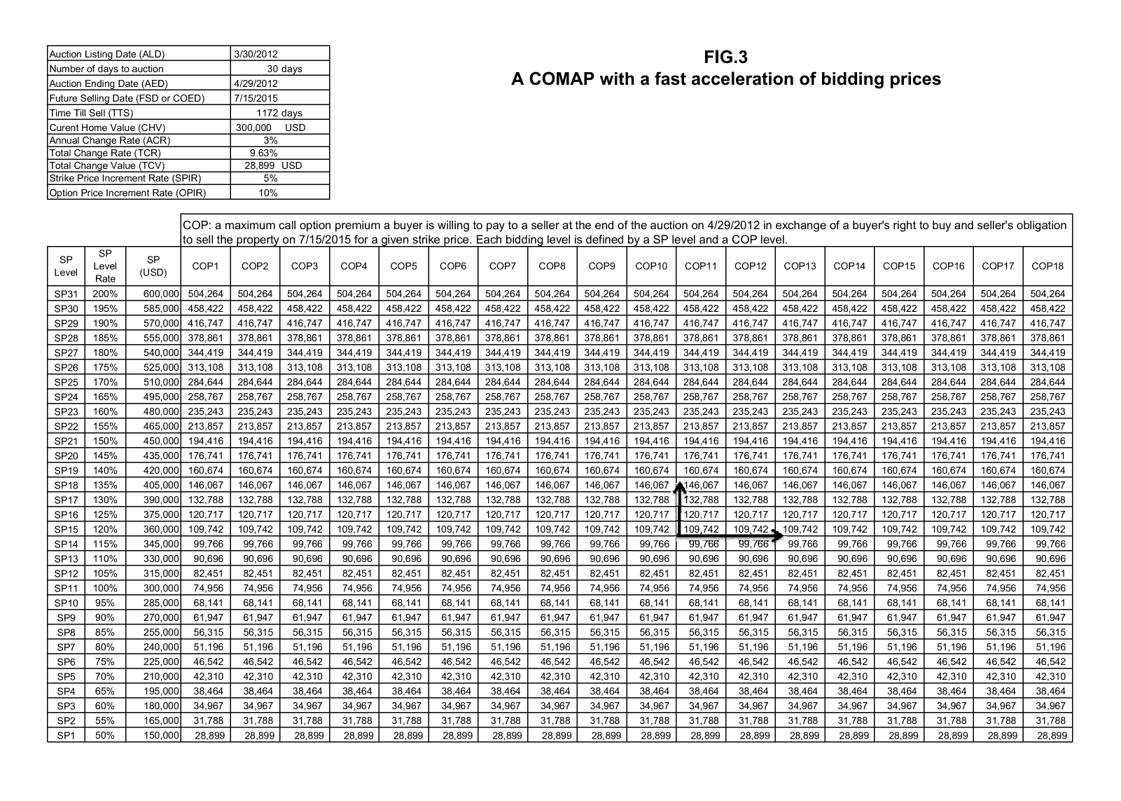

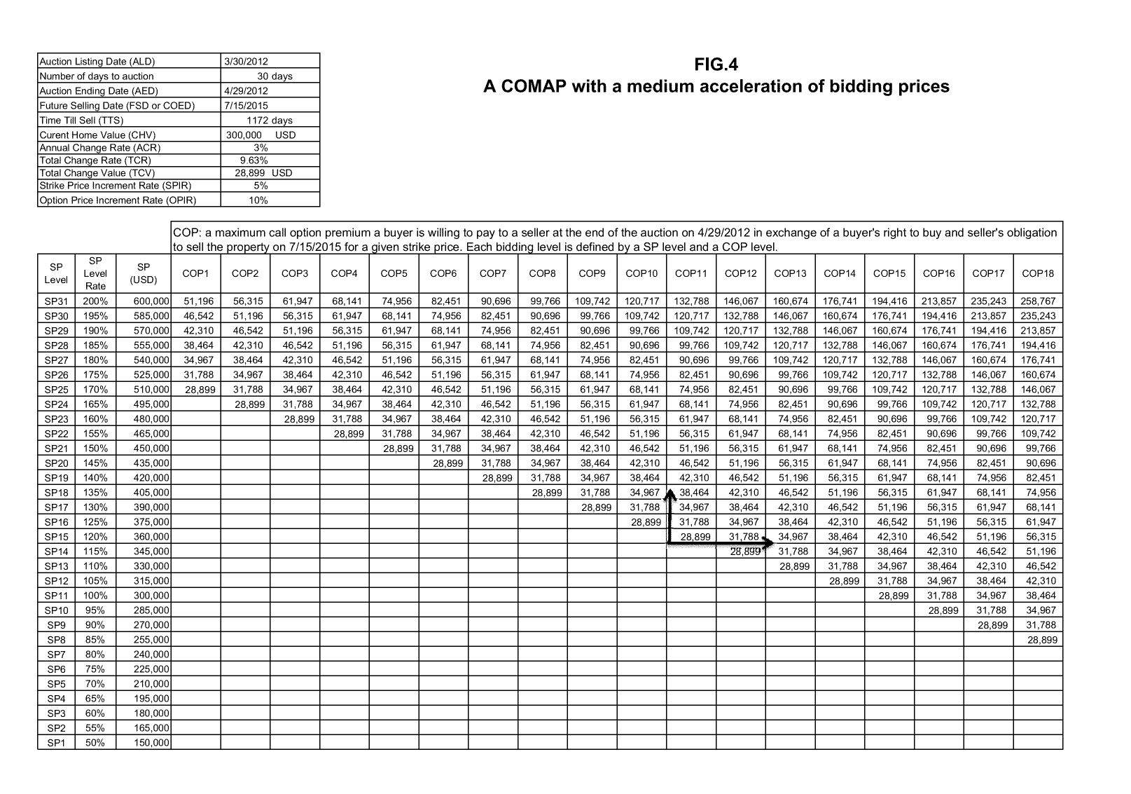

Now in accordance with aspects of this disclosure, illustrated below is a method and process to create and auction a series of call options, a series of put options and a series of spread options together with an example shown in FIG. 2.
1. Property ID number: A property seller logs on the auction website and initiates a property listing. Website automatically creates a unique property identification number for each property listed
2. ALD: as recorded by website while seller is listing the property and activating an auction. In this example shown in FIG. 2, the ALD is Mar. 30, 2012.
3. AED: as input by a seller or calculated by AED=ALD+seller selected number of days to auction. Each auctioning property will have one AED. In the example shown by FIG. 2, the AED is Apr. 29, 2012. In practice, the auction can be configured to end at 11:59:59 PM of an AED.
4. COED or OED: as input by a seller as the future selling date. In the example shown by FIG. 2, the seller selected to sell the property on Jul. 15, 2015, therefore the COED or the OED is Jul. 15, 2015.
5. TTS: as calculated by TTS=COED−AED is the total number of days till sale after auction is closed. In the example shown by FIG. 2, total number of days till sale is 1172 days, approximately 21 months.
6. CHV: as input by seller. The CHV is an approximate number that can be easily found from open sources, such as Realtor.com, Zillow.com, Trulia.com, and Redfin.com and also from any licensed realtor or even from a property owner's own approximation. One utility of this CHV is for the calculation of various levels of strike prices for the series of call options being created. A SP can be a percentage of the CHV; the percentage can be any percentage greater than zero, e.g., 50%, 100% or 200%, etc. Further the price difference from one SP level to the next SP level can be defined by using a strike price incremental rate (SPIR) which can be a percentage greater than zero, e.g., 5%. For example, with a starting SP equaling to 50% of the CHV, and a 5% SPIR for each higher SP levels, the website can generate and display a series of SP level prices equaling to CHV times 50%, 55%, 60%, and 65% till 200% or as higher as buyer is willing to bid on. Obviously a smaller SPIR will results in more SP levels for buyers to bid on. As one can see, it is not necessary that the CHV be accurately reflective of the property's real current value or even anywhere near accurately reflective of the property's real current value, because the WSP which is the future selling price is determined by an auction process. In the example shown by FIG. 2, the CHV is $300,000.
7. ACR: as input by seller or website operator or pre-installed number. The ACR is an approximate number that can be estimated based on any reasonable assumption, and can be input by a seller for the subject property being listed, or input by website operator or even pre-installed in the auction website database according to property types, property locations, and economic conditions, etc. The website operator and website pre-installed ACR number may provide more consistency in the subsequent calculations, therefore can be configured to overwrite any seller input ACR. An ACR can be a percentage number, can be a positive percentage number or a negative percentage number, for examples, any numbers from −40% to 40%. Based on historic real estate market conditions, one might see a reasonable ACR to use is −10% to 10%, or 3% as an example. One will also see it is not necessary to have an ACR that is accurately or anywhere near accurately reflective of the property's real appreciation rate or real depreciation rate. In accordance with one aspect of this disclosure, the ACR is used to calculate a total change value (TCV) of the property from AED to the COED by the formula of TCV=CHV*TCR, where TCR=ACR*(COED−AED)/365. The TCV is then used to calculate a series of call option premiums (COP) under each strike price level by the formula of COP=TCV*(1+COPIR) where the COPIR is a COP incremental rate from one level to the next adjacent level. For example, a 10% COPIR would mean the increment of COP is 10% from one level of COP to the next level of COP. As one can see, by selecting a CHV, an ACR and a COPIR, the website can generate a series of COPs under each CHV and display them under each SP level for buyers to bid on. Once again, an ACR of this disclosure accurately reflective of real property appreciation or depreciation is not necessary because the WCOP is determined by an auction process. Further, for the reason that a wide range of COPs are generated and displayed for buyers to bid on, there is little need, when calculating COPs for buyers to bid on, to take into account of the option's time value changes during the auction period of 30 days or 60 days from ALD to AED. The ACR can be setup such that each property on the website has one ACR number, and not all the properties on the auction website have the same ACR. In the example shown by FIG. 2, the ACR is 3%.
8. TCR: as calculated by TCR=(ACR/365)*TTS is the total change rate of the property value from AED to COED. In the example shown by FIG. 2, the TCR is 9.63%, calculated by (3%/365)*1172.
9. TCV: as calculated by TCV=CHV*TCR is the total changed value of the property from AED to COED. In the example shown by FIG. 2, the TCV is $28,899, calculated by $300,000*9.63%.
10. SP: as calculated by SP=CHV*SP Level Rate” is the property strike price. SP Level Rate is set up by the website operator or a default number to simply create various levels of strike prices for potential buyers to bid on. In theory, the SP Level Rate can be any theoretical numbers, and during the period from AED to COEP, one can reasonably assume the Level Rate is 10% to 1000% and more practically 50% to 500% based on home price appreciation/depreciation history across the US. Website operator has the option or liberty to choose any reasonable SPIR to create either more or less SP levels that will result in either smaller price difference or larger price difference between and among all the SP levels. In practice, once set, e.g., to a 2.5% or a 5% SPIR, there is little need to change the SPIR or SP levels. In the example shown by FIG. 2, the SP Level Rates from 50% to 200% are displayed with a 5% SPIR, as a result, the SP levels are created from $150,000 (50% of CHV) to $600,000 (200% of CHV), and all SP levels in between with a $15,000 ($300,000*5%) increments between any two adjacent SP levels. In auction practice, the SP Levels may be setup such that, after any initial bid, any SP Levels that are lower than the SP level received an initial bid will be disabled, and will be no longer available to bid.
11. COP: is a call option premium price. The first available COP at any given SP Level is the TCV amount calculated by TCV=CHV*TCR as described earlier. The rest of COPs within each SP Level is calculated by the formula of COP=TCV*(1+COPIR). In theory, the COPIR can be any theoretical numbers, but to ensure the availability of reasonable premium levels for buyer to bid on, a COPIR should be reasonably implemented so there is adequate jump in COP amount from one level COP to the immediate next level COP. Website operator or programmer has the option or liberty to choose any reasonable COPIR to create either more or less levels that will result in either smaller COP difference or larger COP difference between and among all the COP levels. In practice, once set, e.g., anything from 5% to 20%, there is little need to change the COPIR. In the example shown by FIG. 2, a 10% COPIR is used. In auction practice, the COP Levels within each SP Level may be setup such that, after any initial bid, all COP Levels that are lower than the COP level received an initial bid will be disabled, and will no longer be available for bid, therefore future buyers can only bid on higher COP levels; or for the same COP value received a bid, a higher SP level.
12. SP-COP Call Option MAP (COMAP): as calculated by the Step-10 and Step-11 above. A map is now formed displaying all available call options each having a SP value and a COP value. As one can see, each available for bid call option can be characterized by a SP Level and a COP Level. In auction practice, the call options available for bid are set up such that the next bid is always either at a higher SP level or within the same SP Level a higher COP level, therefore one can see the bidding direction is from bottom to top and from left to right as shown in FIG. 2. Further referring to FIG. 2, for example, if a first buyer places a bid at SP9-COP2, then the next available call options for bid are SP9-COP3 and SP10-COP2 and any other call options further to the right levels and further to the top levels. Any one skilled in the art can recognize, as buyers begin to bid, the COMAP is shifting to show more of higher level SPs as needed and more of higher level COPs as needed so that available call options will be properly displayed. If a property seller lists a property for auction with a very long TTS period, the COMAP may show a higher SP level to start with because of a potentially significantly higher future selling price. Additionally, one skilled in the art can also recognize that COMAP can be displayed in other formats. As an example shown in FIG. 3, the first available COP for each SP level is not the amount of TCV, rather increases with a COPIR amount. COMAP shown in FIG. 3 is a much more accelerated in SP and COP prices along the bidding direction. The call option auction can also offer a COMAP with a medium accelerated SP and COP prices by setting up COMAP as shown in FIG. 4.

To give one example by referring to FIG. 2, at the start of auction, one available call option for buyer to bid is one characterized in the map by SP12-COP2 with a SP=$315,000 and COP=$31,788. If a buyer bids and wins this call option, then the buyer pays the property seller a COP of $31,788 and in exchange the property seller grants the winning buyer the right to purchase the underline property for $315,000 on Jul. 15, 2015 the COED, and the seller is obligated to sell the property to the buyer if buyer exercises the option to buy.

Put Option—A property seller pays a buyer a put option premium in exchange of 1) a seller's right to sell the property and 2) a buyer's obligation to buy the underline property if seller exercises the put option right to sell.

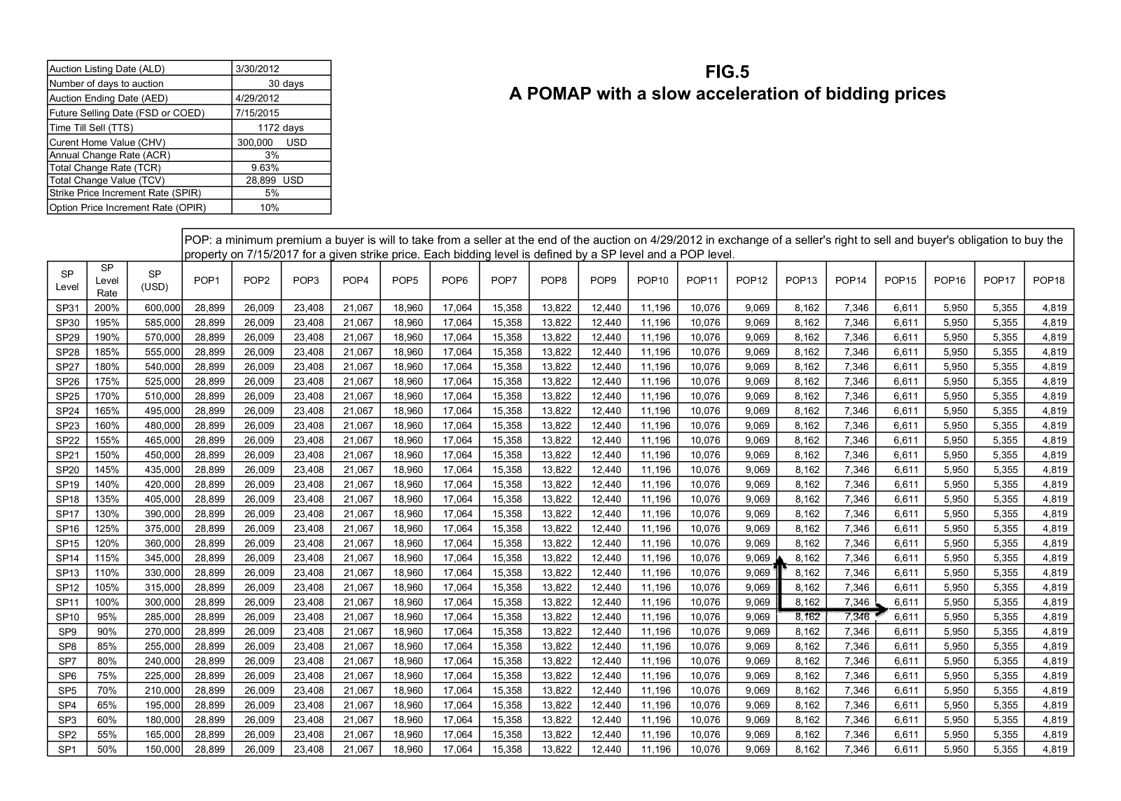

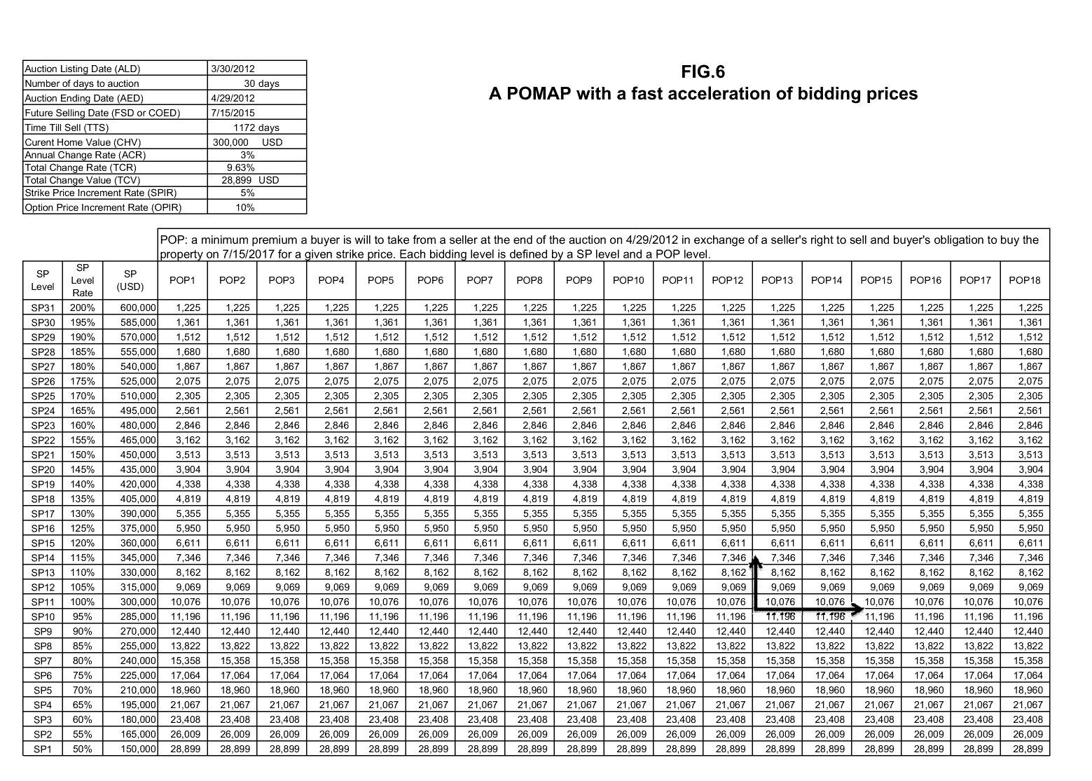

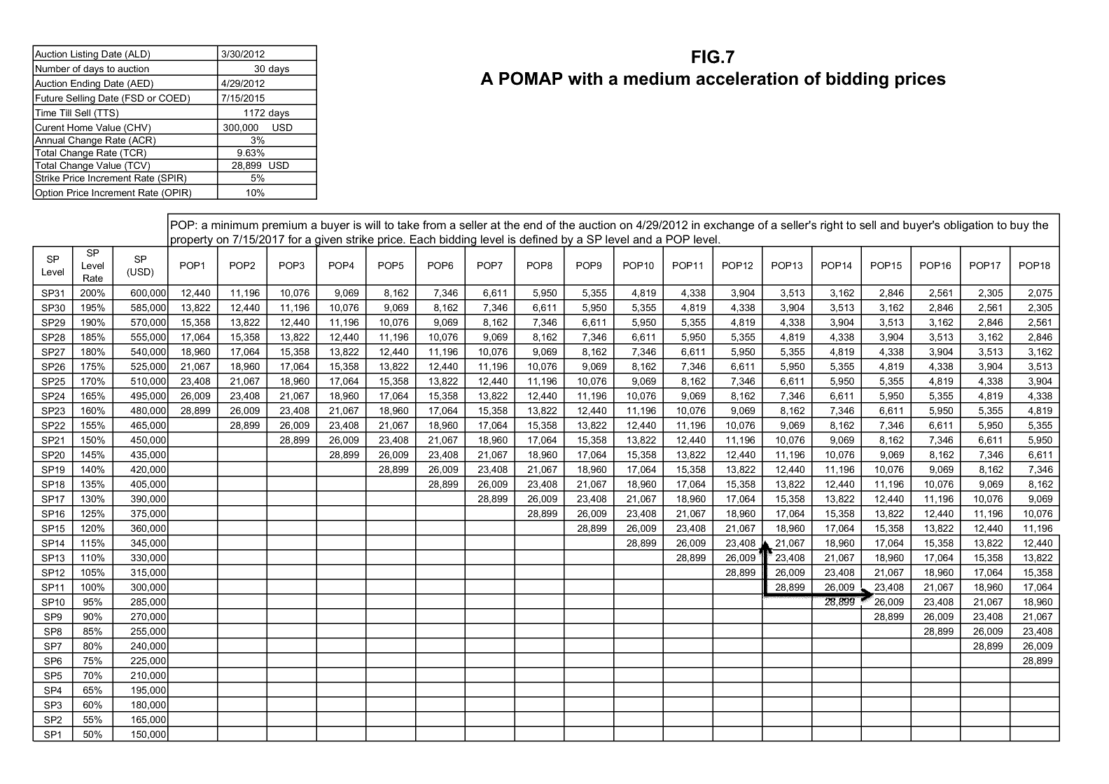

Recall in the call option case disclosed above, a property buyer purchases the right and only the right (not the obligation) to purchase a property, the buyer may or may not exercise the option to buy the seller's property, especially when the property value goes down after the seller and buyer have entered a call option agreement. In accordance with further aspects of this disclosure, a method is illustrated to create a series of put options and further for a property seller to auction the put options. The objective for a seller to list the put options for auction is to find a buyer who is willing to take the minimum amount of a put option premium from the seller in exchange for winning buyer's obligation to purchase the property for the highest future selling price a buyer is willing to pay. So in the put option scenario, the property seller pays the auction winning buyer a winning put option premium (WPOP) and in exchange retains the right to sell underline property to the buyer at a future time (POED) for a winning strike price (WSP). With certain terminologies clarified, one can derive to a conclusion of a put option map (POMAP) as showing in FIG. 5 where a series of put options are generated and displayed each comprising of a put option premium (POP) and a strike price (SP). In the calculation process, a CHV, an ACR, SPIR are used the same way as they are used for the COMAP generation. The ACR is the annual price change rate, it is only an artificial and indicative rate for use in calculation of a TCR and TCV, and they are subsequently used for the calculation of POP amount for each POP level. A proper put option premium incremental rate (POPIR) is selected to control the gap between each POP so that adequate levels of POP are available for buyers to bid on. As one can see from the POMAP shown by FIG. 5, each available for bid put option can be characterized by a SP Level and a POP Level. In auction practice, the put options available for bid are set up such that the next bid is always either at a higher SP level or within the same SP Level at a higher POP level (a higher POP level means less POP money the property seller needs to pay to the property buyer), therefore the bidding direction is from bottom to top and from left to right as shown in FIG. 5. Further referring to FIG. 5, for example, if the first buyer places a bid at SP16-POP5, then the next available put options for bid is SP16-POP6 and SP17-POP5 and any other put options further to the right levels and further to the top levels. Any one skilled in the art can recognize, the POMAP is shifting to show more of higher level SPs as needed and more of higher level POPs as needed so that available put options will be properly displayed. Showing higher SP levels is especially more appropriate when property owner wishes to sell property further into a much longer future, e.g., having a very long TTS and also in the case the real estate market is moving upward dramatically, therefore property buyers may have to bid on higher SP levels. Additionally, one skilled in the art can also recognize that POMAP can be displayed in other formats. As an example shown in FIG. 6, the first available POP for each SP level is not the amount of TCV, rather decreases with a POPIR amount from lower to higher SP level. POMAP showing by FIG. 6 is a much more accelerated in reduction of the POP amount along the bidding direction. One can also offer a POMAP with a medium accelerated reduction in POP amount by setting up POMAP as shown in FIG. 7.

To give an example by referring back to FIG. 5, at the start of auction, one available put option for buyer to bid is one characterized in the map by SP10-POP4 with a SP=$285,000 and POP=$21,067. If a buyer bids and wins this put option, then the property seller pays the buyer a POP of $21,067 and in exchange the property seller retains the right to sell the underline property to the buyer for $285,000 on Jul. 15, 2015, and the buyer is obligated to purchase for $285,000 on Jul. 15, 2015 if the property seller exercises the right to sell.

In accordance with further aspects of this disclosure, the more accurate call option prices (COP) and put option prices (POP) at various levels of strike prices (SP) can also be calculated the way stock options are priced. For example, COPs and POPs can be calculated based on five commonly known parameters that affect option prices: 1) CHV, 2) SP, 3) TTS, 4) Interest rate, for example a rate based on LIBOR, and 5) Volatility which may be calculated by using property's historic prices, such as monthly published property prices for the previous 12, or 24 or 36 months. Such property prices are published by some online real estate service company for example Zillow.com where one can obtain historic prices perhaps with a fee. By considering all these factors, the series of COPs and the series of POPs created for the COMAP, POMAP and CPMAP will be more reflective to the real option premium as one would obtain by using various option pricing models. However, as pointed out earlier, since there are a wide range of COPs and POPs under each SP level for buyers to bid on, and further the WCOP and WPOP are determined through the auction process, true option values of COPs and POPs are not necessary. Even if a true COP or POP is listed, it will be just one bidding value for buyers to bid on.

Spread Option—A property buyer pays a seller a call option premium in exchange of 1) a right to buy and 2) a seller's obligation to sell the underline property if the buyer exercises the call option right to buy; and at the same time, the seller pays a buyer a put option premium in exchange of 1) a seller's right to sell and 2) a buyer's obligation to buy the underline property if the seller exercises the put option right to sell.

A property seller can potentially sell a property by only selling a call option to a buyer, or by only purchasing a put option from a property buyer. Since of the two options (one call option and one put option), seller has only one obligation to sell the property to the call option winner, so seller, in fact, can sell a call option and buy a put option on a same underline property with the same OED. In fact, a property seller may gain added assurance to successfully sell the property by executing a put option in addition to executing a call option. For the property seller, with a combination of buying a put option and selling a call option, seller can successfully hedge against the risk that the property value goes down dramatically. For the property buyer, with a combination of buying a call option and selling a put option, buyer can successfully hedge against the risk that the property value goes up dramatically.

A seller who enters into both a call option contract and a put option contract effectively executes a spread option contract. Seller's call option contract and put option contract may be executed with two different potential buyers. For example, for seller's underline property, a buyer-1 can bid and win on a call option auction as shown by FIG. 2 and a buyer-2 can bid and win on the put option auction as shown by FIG. 5. As one can see, the seller has only one obligation to sell to buyer-1 and has the right to sell to buyer-2, so the seller can fulfill seller's obligation if buyer-1 exercises the option to buy. Such spread option contract gives seller a powerful tool to sell the property with a guaranteed sale and a guaranteed selling price range.

Further aspects of this disclosure is that a property buyer can also entered into a call option contract with seller-1 and a put option contract with a seller-2 because buyer has only one obligation to buy as defined by the put option contract. A buyer can also enter into a spread option contract with the same property seller for the same underline property. In this case, a buyer most likely would like to bid on a call option with one SP level and bid on a put option with a lower SP level. For example, a buyer can purchase a call option with the right to buy a seller's property for $315,000, and at the same time can sell a put option with an obligation to buy seller's property for $285,000.

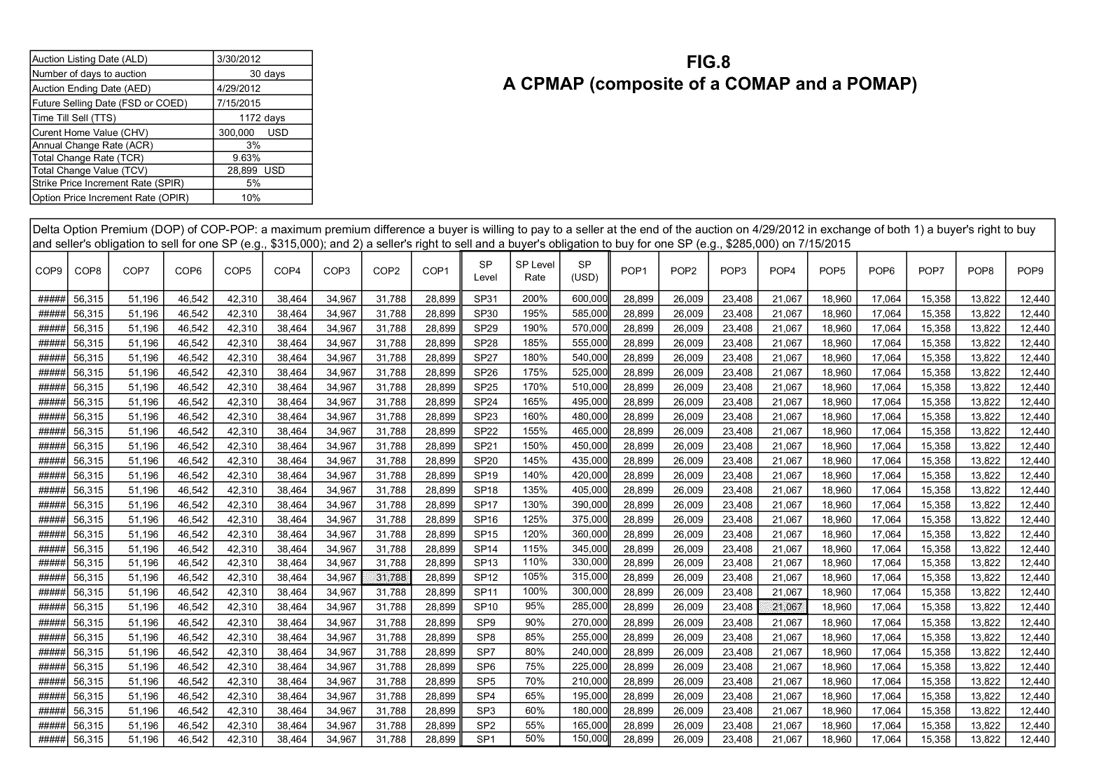

In a spread option auction, an option map that comprising of both a COMAP and a POMAP can be set up as a CPMAP (call and put option MAP) to allow buyer to bid on both a call option and a put option. On a CPMAP, bid is only valid when both a call option and a put option are selected for bid. Upon selection, the website will then calculate the Delta Option Premium by the formula of DOP=COP−POP which could be a net option premium a buyer needs to pay a seller or a seller needs to pay a buyer depending on the SP level and the COP/POP levels the buyer places bids. Buyer's call/put combination selection is reflective of the buyer's speculation of property price movement direction from AED to OED. Shown in FIG. 8 is an example of a CPMAP for a buyer to bid on a spread option that comprising a call option and a put option. For example, a buyer can bid on the call option level defined by SP12-COP2 (SP $315,000, COP $31,788) and can also bid on the put option level defined by SP10-POP4 (SP $285,000, POP $21,067), this spread option contract, once executed, will give the buyer the right to buy the property for $315,000 and the obligation to buy the property for $285,000; the net option premium due in this case is from the buyer to the seller in the amount of $10,721 ($31,788−$21,067). Such spread option gives the seller a powerful tool to sell the property in the future with a guaranteed sale and guaranteed selling price range, and concurrently, gives the buyer a powerful tool to purchase a home in the future with a guaranteed purchase and a guaranteed price range.

Notice if a buyer bid on a call and a put option of the same SP, then the buyer is buying the property at that SP by paying a net WDOP because the buyer would have the right and also have the option to buy at that SP. Obviously the seller, under this condition is selling the property at hat SP price by receiving a net DOP.

Further worth to note is that a buyer, when entering into a call and a put option contract with different sellers, the OED should be the same time or approximately the same time in order for the buyer to make a decision whether or not to exercise an call option right to buy with seller-1 because buyer has to take into account the potential and pending obligation to fulfill in the event the put option seller-2 exercises the right to sell.

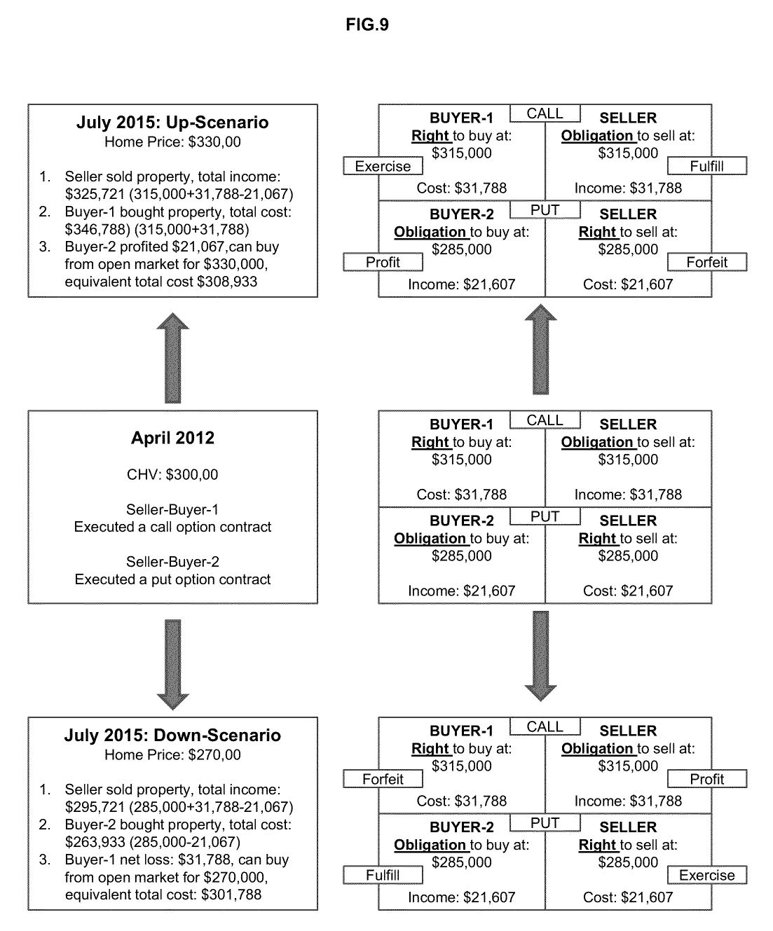

Now let's look at an example by referring to FIG. 9 how a call option contract and a put option contract have afforded a guaranteed sale and a guaranteed sale price range for the seller on either an up or a down market; and for the buyer a guaranteed purchase and a guaranteed purchase price range on either a up or a down market. The middle left of FIG. 9 highlights the current time of April 2012 that a seller and buyer-1 enter into a call option contract and at the same time for the same underline property, the seller and buyer-2 enter into a put option contract. Seller and buyer-1 call option contract defined by SP12-COP2 level guarantees the buyer-1 a right to buy at a WSP of $315,000 with buyer paying seller a WCOP of $31,788; Seller and buyer-2 put option contract defined by SP10-POP4 level guarantees the seller a right to sell at a WSP of $285,000 with a seller paying a buyer-2 a WPOP of $21,067. Now fast forward, it is now July 2015, the market has changed one way or another or remains the same. For example purpose, we assume two scenarios, one the market has gone up, and the property has appreciated 10% in value, so the subject property market value is now $330,000; another scenario is just opposite that the market has go down 10%, now the market value of the property is $270,000. As one can see, for the Up-Scenario, the 2015 value is $330,000, so the buyer-1 is going to exercise the right to purchase for $315,000 and the seller has to deliver the sale at $315,000 to buyer-1. So the seller will sell the property for $315,000 in July 2015. At the same time, the seller will forfeit seller's right to sell at $285,000 to the buyer-2, so the buyer-2 just keeps the put option premium received in April 2012. As a result, 1) the seller has sold the property and total income is $325,721 ($315,000+$31,788−$21,067); 2) buyer-1 has bought the property and total cost is $346,788 ($315,000+$31,788); and 3) the buyer-2 has just earned $21,067 without buying anything, but further the Buyer-2 can go out to the open market buy similar home for $330,000 if buyer-2 decides to do so, therefore buyer-2's total cost would be $308,933 ($330,000−$21,067). Now for the down scenario, the 2015 value is $270,000, so the seller is going to exercise right to sell for $285,000 and the buyer-2 is obligated to buy at $285,000. So the seller has sold the property for $285,000 in July 2015. At the same time, the buyer-1 will forfeit the right to buy at $315,000 so the seller gets to keep the $31,788 premium received in 2012 from buyer-1. As a result, 1) the seller has sold the property and total income is $295,721 ($285,000+$31,788−$21,067); 2) buyer-2 has bought the property and total cost is $263,933 ($285,000−$21,067); and 3) the buyer-1 has lost $31,788 without buying anything, but further, the buyer-1 can go out to the open market buy similar home for $270,000 if buyer-1 decides to do so, therefore buyer-1's total cost would be $301,788 ($270,000+$31,788). Form the above example; one can see, in April 2012, all parties have managed their July 2015 real estate needs 21 months ahead of time, all were done with a known price range and all were done with a known maximum risk for each party.

Further in accordance with aspects of this disclosure, a property can have three option maps for auction: COMAP for a call option auction, POMAP for a put option auction and a CPMAP for spread option auction. These three auction maps are set up such that the call options in the COMAP and in the CPMAP are correlated, and the put options in the POMAP and in the CPMAP are correlated. A bid of a call option on either the COMAP or on the CPMAP will synchronize on both COMPA and CPMAP that any call option levels lower than the level receives a bid will be no longer available for buyers to bid on both COMAP and CPMAP; similarity, a bid of a put option on either the POMAP or on the CPMAP will synchronize on both POMAP and CPMAP that any put option levels lower than the level receives a bid will be no longer available for buyers to bid on both POMAP and CPMAP. For example, if a buyer placed a call option bid on level SP12-COP2 on CPMAP (referring to FIG. 8) then all levels lower than SP12-COP2 will no longer be available for buyers to bid on both the COMAP (FIG. 2) and the CPMAP (FIG. 8). Similarly, if a buyer placed a put option bid on level SP10-POP4 on the POMAP, then all put option levels lower than SP10-POP4 will no longer be available for buyers to bid on both the POMAP (FIG. 5) and the CPMAP (FIG. 8).

Upon seller listing a property for auction, website creating options on the said property and buyer placing bids on the created options, an auction winning buyer (AWB) will merge through the auction event. Upon winning an option auction, the AWB can exercise the call option right to purchase the property by entering into a purchase contract and by opening an escrow for the AWB and the seller to close the real estate transaction. Similarly, upon completing a put option auction, the seller can exercise the right to sell the property by entering into a purchase agreement and by opening an escrow for seller and the AWB to complete the real estate transaction. Further similarly, the AWB can the property seller can arrange to execute a purchase contract based on the spread option agreement and open an escrow to complete the real estate transaction.

When an option is exercised, a licensed real estate company and its agents may be arranged to draft and to help to execute a purchase contract; other parties such as mortgage providers, home inspectors, home appraisal companies, home warrantee companies, escrow companies can be arranged to provide related services as needed to complete a real estate transaction. Sellers and buyers coordinated by licensed realtor agent may also wish to use home inspector services, if so desired, to document and compare the property conditions at the time of auction and agreed property selling condition at the future time when executing a purchase agreement. The property conditions at the time of executing a purchase contract may be found different than the future selling conditions as documented in the option agreement, such property conditions discrepancy can be addressed by a seller arranging home repair to fix or by a buyer arranging such repair in accordance with the option agreement conditions and terms.

Operations—Property Sellers and Buyers Interface with the Auction Website

In accordance with aspects of this disclosure, a property seller and a property buyer each interfaces with the auction website through the use of an internet enabled device from a remote location with respect to the location of the website server. Both the buyer and the seller visit the website and sign up as customers and will receive login credentials such as user names and password. Website operator(s) and administrator(s) also can remotely access the auction server to maintain the auction website and to keep data updated and safe.

With login credentials, a seller logs in the auction website to create a listing of a property. On the website, a seller, step by step as guided by the website inputs one or more of the following property information such as: 1) home address, city, county, state, zip code; 2) an introduction message to describe the selling features of the property; 3) specifications of the property, for example, number of bedrooms, bathrooms, home size, lot size, number of garages; 4) further description of family room, living room, dining room, air conditioner, utilities, floorings, exterior, roofing, swimming pool, spa, etc; 5) neighborhood information such as school district, schools, churches, police department, library, etc., 6) other miscellaneous information about the properties; and 7) the seller is asked to upload any pictures and videos that may help a buyer to further evaluate the property, a seller completes this step by browsing the pictures and videos on a local hard drive and then upload them to the website server under the listed property. One skilled in the art may also suggest that a property seller uses built-in website features to interface with other sources of property information such as those on MLS listing, Realtor.com, Redfin.com. Zillow.com and Trulia.com, etc so that property descriptions may be imported from the other sources with proper subscriptions and perhaps with paid dues if required. The purpose of seller's description of the property is to provide sufficient property information for a buyer to make a decision whether or not to further investigate the property and to eventually bid on the property. Upon completing the property description step, the seller is asked to continue to provide listing information such as 1) how long does the seller want to list the property for auction or when does a seller want the auction to end, a seller can conveniently choose from a popup calendar and to click on an AED or to use a drop down menu to select how many days to list the auction for; 2) when does the seller intent to sell the property, for example, to use the dropdown menu to choose a month and then a year; the website can then fix the 15^{th} of that month as a default ECD which is then used by the website as COED for the call option and POED for the put option; 3) CHV in seller's opinion. The seller may wish to refer to other sources for such CHV. The website can also be set up so that a CHV on other sources can be imported, for example a property's current value posted on Zillow.com can be extracted as a CHV with the permission of Zillow.com; and 4) a seller to choose which type of options to auction, for example by selecting the proper choices, such as 4a) auction a call option—the property seller receives a COP from a buyer, in exchange is obligated to sell the property to a winning buyer on the COED; 4b) auction a put option—the property seller pays a POP to a buyer, in exchange the seller retains the right to sell the property to the buyer on POED; and 4c) auction a spread option—the property seller receives from a buyer or pays to a buyer a DOP in exchange for an obligation to sell and for a right to sell according to spread option agreement. It is further noted that a seller may set up a reserve SP-COP level in a call option auction, a reserve SP-POP level in a put option auction, and a reserve SP-COP/SP-POP levels in a spread option auction such that if the reserve is not met at the AED, seller's auction can be declared unsuccessful therefore no subsequent execution of any option agreement. Such reserve implementation is important especially for properties may not receive a lot of bids. Upon completing the selection of options to be auctioned, the seller is asked to click on the submitting button then leads the seller to a terms and conditions page where it clearly states all parties' rights and obligations under each chosen auction. After reviewing all the terms and conditions and other legal compliance conditions, the seller is asked to submit and activate the auction. Upon activation, seller receives an email notification summarizing the auction and re-stating all the rights and obligations for the seller and for a wining buyer. Aspects of this disclosure is a goal to market and sell the option auction services to many property sellers and potential sellers thus the website will then have a plurality of listed properties for auction of call options, put options and spread options.

From the buyer side, a buyer visits the auction website to find a property that is available for sell at a future time. When performing property search, a buyer may provide certain search criteria to help narrow down choices of properties of interest. Among many criteria, some search criteria may include one or more of these: 1) Future selling date (FSD) which the seller input at the time of listing property for auction; buyers especially investors, may also be interested in home for auction without a limitation to the time because they are looking for investment opportunities, so one may also omit such criteria to allow website to include properties regardless of FSD; 2) Location of the property, this can be achieved by selecting the state, county and city a buyer wishes to buy the property at the future time; and 3) a property's CHV that a buyer is willing to consider.

After buyer submitting one or more search criteria highlighted above, the website then performs a search within the database, and generates a list of properties that match these criteria. These properties are displayed on a webpage with the following main contents for each property: 1) Main picture, and a hyperlink to more pictures of the property to show the exterior and interior and overall conditions of the property; 2) Optional video tour of the property that can further enhance the buyer's knowledge of the property; 3) Property address, city, county, state and zip code; 4) Number of bedrooms, bathrooms, and home's living space, lot size, etc., 5), available option auctions (e.g., a call option auction and/or a put option auction and/or a spread option auction as elected by the property seller at the time of listing), and current highest bids on all option auctions; and 6) A link to home's detail page that takes a buyer to a detail page show complete description and more features of the property; and in addition, on the detailed page, a “save this property” hyperlink is provided allowing a buyer to save the property if the property is of interest and buyer wishes to do further research including a physical tour of the property; another hyperlink of “place a bid” is provided for buyer to view current bid and place bid once buyer have done complete research and ready to bid. In further aspects of this disclosure, a buyer may choose multiple candidate properties and save them under buyer's username account stored on the website. With all the candidate properties in hand, a buyer, at buyer's will and choice, may contact a real estate agent directly or indirectly through the website operator(s) or through the website linked advertisements, and arrange to tour the properties of interest to further verify the conditions of the properties and to document the conditions of the properties. Further, a property inspection professional may be hired by a buyer to further inspect and document in details of the property conditions. At the end of property investigation, buyer decides and chooses the finalist property or properties the buyer will place a bid. When a buyer logs on to the auction website again, a hyperlink of “my saved properties” would then take the buyer to the list that contains all the saved properties of interest, within that list, the finalist property appears. The buyer select the finalist property, and then click on the “place a bid” hyperlink which will then take the buyer to a bidding page. Displayed on this bidding page includes key information that a bidder needs to review, such as 1) address, city and state along with an optional property identification number that the website can generate automatically every time when a property is listed by a seller, 2) auction status, for example, “open” or “closed” and also display the auction ending date (AED), 3) current home value (CHV), 4) current highest SP bid, 5) current highest COP bid in a call option auction, and current highest POP bid in a put option auction, and current highest COP/POP bids in a spread option auction; further under each listed option auction, a hyperlink is provided that can take the buyer to the respective option map, for example, a COMAP, a POMAP or a CPMAP. On these MAPs, the buyer can place proper bids. A buyer can choose to just bid on the COMAP if only interested in a call option, or bid on the POMAP if interested in a put option, or bid on a CPMAP if interested in a spread option; buyer can also separately bid on a COMAP and a POMAP if decide so. Upon the buyer placed a bid on a option, either a call or put or spread, the buyer is directed to a “confirm bid” page, on this confirmation page, a disclaim will be displayed for example to remind that a bidder is entering into a legally binding option contract that buyer, if wins the auction, will pay a COP to the seller in exchange of the right to buy the underline property in a call option auction; or a buyer will receive a POP from the seller in exchange of obligation to buy the underline property in a put option auction; and for a DOP (COP-POP) due to the seller or due to the buyer in a spread option auction. Upon confirming all conditions and terms, and acknowledging the understanding of all legal obligations, buyer is then asked to submit the bid by clicking on a submit button, and subsequently, the buyer receives an email confirmation highlighting bid details, thus completing a bidding process.

In further aspects of the disclosure an outbid notification is implemented so that a buyer will receive an email alert that buyers' bid is now outbid by another higher bidder who has offered a higher SP level or a higher COP level or combination of the two for a call option auction; or outbid by another higher bidder who has offered a higher SP level or a higher POP level (less amount of money buyer is willing to take from a seller) or combination of the two for a put option auction; or outbid by another higher bidder who has offered a spread option that has a higher SP level and a higher DOP amount (COP-POP). Upon receiving an outbid notification, the buyer can log on to the website again to evaluate and to place a more competitive bid. This process continues until the auction ends on the scheduled AED with an auction winner merged. Once the auction has ended, a notification email is generated by the website and is sent to the winning buyer, seller and the website operator(s), thus completing an auction event of the underline property. Coordinated by the auction operation and/or along with real estate professionals, the auction winning buyer (AWB) then pays the seller the winning COP (WCOP) in a call option auction, or receives a winning POP (WPOP) payment from the seller in a put option auction, or pays the net winning DOP (WDOP) by the buyer to the seller or the seller to the buyer in a spread option auction. Concurrently, the buyer and seller, coordinated by the website operation and/or along with the real estate agent, enter and execute the option contract with all terms and conditions clearly specified. The option agreement (a call or a put or a spread contract) then provides the terms and conditions for a purchase agreements when a buyer or a seller exercises the right to buy or to sell the underline property. In practice, proper notification should be arranged for the AWB to inform a seller 30-60 days prior to the COED whether or not to exercise the call option right according to a call option contract or spread option contract; and for the seller to inform the AWB also 30-60 days prior to the POED whether or not the seller is to exercise the put option right to sell according to a put option contract or a spread option contract.

### Additional Embodiment

### Auction Winning Buyer (AWB) to Trade Call Option Right and Put Option Obligation

Following in a successful auction of a call or a put or a spread auction event, the auction winning buyer (AWB), in accordance to aspects of this disclosure, can decide to further trade the call option right (COR) won from the call option auction or the spread option auction, and to trade the put option obligation (POO) won from the put option auction or the spread option auction. Due to real estate market condition changes and related changes in supply demand nature of the underline property, the values of the buyer's COR and the buyer's POO are changing. It is the change in value of COR and POO that investors, individuals or corporations have the opportunities and desires to make profits on the transactions by correctly speculating the real property value change and change direction, and by executing related option contracts. It is also the change in values of the COR and POO that forms the basis for COR and POO trading and therefore further provides a vehicle for investors, individuals or corporations to participate in the ownership of the COR and POO in real estate options, and further creates the liquidity of the real estate properties.
1. COR trading: The buyer's call option right to buy according to a call option can be traded. A property buyer who bids a call option auction event wins a call option and becomes the AWB who executes a call option contract with the seller. This call option contract defines the COR for the AWB to purchase the underline property for a WSP on the COED, and for the said COR, the AWB pays the property seller an option premium in the amount of WCOP on the AED. During the period from the AED to the COED, the underline property may change value due to many factors including but not limited to economic conditions, supply and demand nature, government policy, interest rate, lending policies, etc. As a result of these changes, the value of such COR to buy the underline property for a known and fixed price of WSP will also be changing. The COR's value also changes as a function of the time left on the call option contract till the COED. Due to the nature of the COR bearing a value and such value is subject to change, the COR becomes tradable for a price of call option right price (CORP) prior to its expiration on COED. The CORP represents an amount of money that the AWB will receive from a new property buyer in order for the new property buyer to have the assigned right to buy underline property according to the said call option contract. It becomes apparent that the CORP amount the AWB receives when selling the COR may be different from the WCOP the AWB paid the property seller, therefore the AWB may realize a profit by selling at a CORP higher than the WCOP if the AWB has correctly speculated the property value movement direction. Obviously the AWB may also lose money by selling at a CORP less than the WCOP due to having incorrectly speculated the real estate price movement direction. It is also noted that the COR may be sold back to the property seller at a CORP and such CORP may be greater or smaller than the original WCOP amount the property seller received from the AWB. It is further noted that the COR can be traded again and again prior to the COED therefore such COR trading creates liquidity to the underline property.
2. POO trading: The buyer's put option obligation to buy according to a put option can be traded. Similarly, while waiting for seller's decision whether or not to exercise the put option right to sell the property, the AWB can also sell the POO to a new property buyer for an amount of put option obligation price (POOP). The POOP represents an amount of money that the AWB needs to pay to the new property buyer in order for the new property buyer to fulfill the obligation to purchase the underline property according to the said put option contract. The POOP may be sold for greater or smaller amount of money than the initial WPOP the AWB received from the property seller due to the underline property's value change and the time left on the put option contract. It is noted that the POO may also be sold back to the property seller for a POOP and such POOP may be greater or smaller than the original WPOP amount the property seller paid to the AWB. It is further noted that the POO can be traded again and again prior to the POED therefore such POO trading creates liquidity to the underline property.
3. CRPO trading: The buyer's composite Call option Right and Put option Obligation in a spread option can be traded. Further similarly, the buyer's COR and POO collectively call right and put obligation (CRPO) in a spread option are tradable for the amount of money of spread option transfer price (SOTP). The SOTP represent the amount of money the AWB will pay or receive from a new property buyer in order for the new property buyer to have the assigned right to purchase the underline property (e.g., for one strike price level according to the COR in a spread option contract) and also an obligation to purchase the underline (e.g., at another strike price level according to the POO in a spreads option contract). Again due to market condition changes, the values of the composite CRPO in the spread option changes, therefore SOTP may be greater or smaller than the winning delta option price (WDOP) that paid by the AWB to the property seller at the end of the property auction. It is noted that the CRPO may also be traded back to the property seller for a SOTP and such SOTP may be greater or smaller than the original WDOP amount transacted between the seller and the AWB. It is further noted that the CRPO can be traded again and again prior to the OED therefore such CRPO trading creates liquidity to the underline property.

Further in practice, listing the COR, POO and CRPO for sale or auction can be achieved by implementing a hyperlink addition to the listed property webpage. For example, when a property auction ended, the AWB receives an email notification. In that email notification, a hyperlink is provided to allow the AWB to click on and to go back to the auction website. On the auction website, the AWB is asked to answer a question for example: Are you interested in selling the COR or the POO or the CRPO you won from the auction event? If the AWB answers yes, then the website will setup the COR, POO and CRPO for auction for a period of time (e.g., number of days) specified by the AWB. The auction will list the WCOP of the call option, WPOP of the put option and WDOP of the spread option so the new property buyer can see the values of each of these winning option prices. Under a COR auction, CORPs of lower than WCOP and higher than WCOP are both available for bids to begin with the auction, but once a bid is received, only higher CORPs are available for further new buyers to bid on since the CORP represents the amount of money the AWB is willing to take from the property buyer in exchange of giving up the COR to the new property buyer. Under POO auction, POOPs of higher and lower than WPOP are available for bid to begin with the auction, but once the POO gets a bid, then only lower valued POOPs are available for bid since POOP represents the amount of money the AWB is willing to pay to the new property buyer in exchange of passing on POO to the new property buyer. Under a CRPO auction, the spread option transfer price (SOTP) higher and lower than the WDOP are available for new property buyers to begin with the auction, but once a bid is received, only higher amount of SOTP is available for further new property buyers to bid on since typically the spread option will have a higher SP in the COR and lower SP in the POO.

When a new property buyer find the property, the new buyer will see that the property's auction status is “auction closed” but will see all other information such as home details, CHV, WSP and WCOP in a call option auction, WSP and WPOP in a put option auction, and WSP and WDOP in a spread option auction, in addition the new buyer will be able to see the COR, POO and/or CRPO are for auction if AWB elected to have them for further auction after the AED, and therefore the new property buyer can place bids on these rights and obligations. The new property buyer can be the original property seller, this is useful especially if the property seller changes mind and do not want to sell the property anymore. As readers can see, such utility and flexibility of option trading is a powerful tool for real estate investors who buy and sell options to profit based on correct prediction of real estate price movement directions and never intend to take a physical delivery of a property either in selling or in buying, therefore implementation of this related aspects of this disclosure can provide an investment vehicle for individuals, groups and companies to participate real estate investment therefore creating the much needed real estate liquidity. Anyone skilled in the art will also recognize auction is not the only way to trade these rights and obligations, direct sales can be one alternative, direct arrangement with the original property seller could be another alternative.

### Further Additional Embodiments

Further in accordance with the aspects of this disclosure, a property seller can choose to fix a strike price as the future purchased price, and have buyers to bid on the call option right. For example for the property shown in FIG. 8, the property seller can choose to set the July 2015 property selling price at $315,000, the buyers will bid only on the call option premium the buyer is willing to pay in exchange of seller's obligation to sell at $315,000 if buyer exercise the right to buy; Similarly, the seller can also auction one put obligation to buy the property at one strike price. For example for the property shown in FIG. 8, the property seller can choose to set the July 2015 property selling price at $315,000, the buyers will bid only on the put option premium the seller will pay the buyer in exchange of the buyer's obligation to buy at $285,000 if seller exercises the option to sell. Further similarly, a call option at one strike price and a put option at another strike piece as a spread option can be set up for auction, and the buyers will bid on a DOP=COP−POP to win the right to buy at one price (e.g., $315,000) and the obligation to buy at another price (e.g., $285,000).

Further still in accordance with the aspects of this disclosure, a property seller can choose to fix a COP and/or a POP, and have the buyers to bid on the SP for each COP and/or POP. For example for the property shown in FIG. 8, the property seller can choose to set a COP of $31,788 the buyer needs to pay the seller in exchange of the right to buy the property for a strike price a buyer is will to pay in July 2015; Similarly, the seller can set on POP of $21,067 the seller is willing to pay to the buyer in exchange of buyer's obligation to buy at the highest SP the buyer is willing to pay in July 2015. Further similarly, a seller can set a DOP of $10,721 ($31,788−$21,067) that a buyer needs to pay the seller in exchange of the highest SP the buyer has the right to buy, and at the same time, the highest SP the buyer is obligated to buy.

Further still in accordance with the aspects of this disclosure, the above described internet based auction is just one way to auction the created call options, put options and spread options, anyone skilled in the art can also recognize many other alternative ways to accomplish the option bidding process, to execute the option agreements between buyers and sellers; and further to trade the rights and obligations in these options. For example, the auction function and tasks can be conducted offline, such as in a physical place or remotely by parties with a phone, a fax, papers, pens, pencils or any similar devices and tools that allow the engagement of sellers and buyers.

Further in accordance with the aspects of this disclosure, the above described internet based auction is just one way to create call options, put options and spread options on a property, anyone skilled in the art can also calculate the call options, put options and spread options under each SP level and arrange these options for auction so that a property seller can sell a call option to a buyer and a buyer can sell a put option to a property seller.

### CONCLUSION

Accordingly, a reader will see aspects of this disclosure in creating options on a property, in auctioning and further trading the options can be used to benefit buyers, sellers and investors:
1. It allows a seller to schedule a sale and to sell a subject home, and a buyer to schedule a buy and to buy a home at the best suitable time based on needs, family situations, economic conditions, personal goals, life styles, preference, obligations, etc.
2. It provides a piece of mind, knowing the future selling and future purchasing are guaranteed with a guaranteed transaction price range between a seller and a buyer, therefore a property seller can successfully hedge against the risk of the home price going down too lower to lose equity by the time the seller needs to sell; and a property buyer can successfully hedge against the risk of the home price going up too high that it becomes unaffordable by the time the buyer needs to buy the property.
3. It permits a significant cost saving in real estate transaction. The auction service may charge a fee in a form of a small property auction listing fee or a small commission on an option premium or a small commission on the future selling price of a property. Whatever forms the auction service fee may be, it is a much smaller amount compared to either a seller's agent commission or a buyer's agent commission collectively a 5-7% of home selling price. By implementing aspects of this disclosure, only one real estate agent is needed with reduced responsibility and work load so one can expect a 50% or more reduction in real estate commission cost. Such reduced cost further promotes willingness for home buyers and sellers to involve in more frequent real estate transactions, therefore adding liquidity to the real estate market.
4. It permits a property seller to purchase the call option back or to sell the put option back to the buyer therefore property seller can retain the property. It also permits a property buyer to sell the call option back to the property seller or to buy back the put option from the property seller. This is very helpful if a seller or a buyer changes mind during the period from AED to OED. Such flexibility once again promotes willingness for home buyers and sellers to involve in more frequent real estate transactions, therefore adding liquidity to the real estate market.
5. It provide an investment vehicle permitting a home seller to make a net profit by successfully selling a call option and if the call option is not exercise by a buyer as a result of a seller having correctly speculated the property price movement; or a home buyer to make a net profit by successfully selling a put option and if the put option is not exercised by a seller as a result of a buyer having correctly speculated the property price movement.
6. It further provides an investment vehicle permitting investors to manage a portfolio of call options and put options on a plurality of properties in order to profit by correctly speculating the real estate price movement directions, therefore to add liquidity to the real estate market.
7. It further permits option implementation and transaction for other assets such as aircrafts, ships, boats, collectible cars, commercial buildings, restaurants, manufacture facilities, jewelries, diamonds, precious metals, financial instruments, such as bonds, notes, etc., therefore promoting further economic activities
8. It further permits a creation and utilization of viable and meaningful economic and consumer behavior indicators by the federal agencies such as the commerce department and by private sectors engaging in related commerce activities if a plurality of auctions and a plurality option trading and related price movements are properly indexed. Such indices may be utilized as a new effective and accurate gauge to measure the economic activities and economic growth.

What is claimed is:

1. A method to create a series of call options on a property for the seller to sell one, preferably the highest priced call option, and to create a series of put options on a property for the seller to buy one, preferably the lowest priced put option, comprising of the following steps:
1.1. Auction website owner or operator setting up an auction website on a computer server with hardware such as storage drivers, memories, processors, peripherals; and software such as programs, computing algorithms, mathematic formulas, web pages, proper interfaces with users and website operators.
1.2. A seller listing a property on an auction website using one or more of the following: an auction listing date, an auction ending date, a property's future selling date or escrow closing date, and a property current home value, and additional description of a property such as address, home size, bedroom, bathroom, year built, and other aspects of a property.
1.3. Auction website creating a series of call options on the seller's property each call option comprising of a future selling price and a call option premium price.
1.4. Auction website creating a series of put options on the seller's property each put option comprising of a future selling price and a put option premium price.
1.5. Auction website creating a series of spread options on the seller's property each spread option comprising of composite prices of a future selling price and a call option premium price, and a future selling price and a put option premium price.
1.6. Auction website displaying the created call options, and/or put options, and/or spread options for auction for a period of time to sell one or more of the following: 1) the highest strike price along with the highest call option premium price in a call option auction; and/or 2) the highest strike price along with the lowest put option premium price in a put option auction; and/or 3) the combination of 1) and 2) in a spread option auction.
1.7. A buyer searching and identifying a property of interest, and then placing a bid in a call option auction, and/or placing a bid in a put option auction, and/or placing a bid in a spread option auction.
1.8. A winning buyer having won the call option comprising of the highest strike price and the highest call option price or the combination of the two prices.
1.9. A winning buyer having won the put option comprising of the highest strike price and the lowest put option price or the combination of the two prices.
1.10. A winning buyer having won the spread option comprising of the highest strike price and the highest call option premium price or the combination of the two; and the highest strike price and the lowest put option premium price or the combination of the two.
1.11. The winning buyer paying the seller the winning call option premium at the end of a call option auction
1.12. The seller paying the winning buyer the winning put option premium at the end of a put option auction
1.13. The winning buyer paying seller a delta option premium in the amount of a call option premium less a put option premium at the end of a spread option auction; or the seller paying the winning buyer a delta option premium in the amount of a put option premium less a call option premium in a spread option auction
1.14. The winning buyer and the seller entering into a call option agreement that the buyer has the right to purchase seller's property on the future date for the winning strike price;
1.15. The winning buyer and the seller entering into a put option agreement that the seller has the right to sell the underline property to a buyer on the future date for the winning strike price.
1.16. The winning buyer and the seller entering into a spread option agreement that the buyer has the right to buy the underline property from the seller according to the call option right in the spread option agreement; and the seller has the right to sell the underline property to a buyer according to the put option right in the spread option agreement.
1.17. The winning property buyer exercises the right to purchase and to open escrow to complete the purchase of the property from a property seller according to the call option agreement or the spread option agreement; the seller exercises the right to sell and to open escrow to complete the sale of the property to a winning property buyer according to the put option agreement and spread option agreement.

2. The method of claim 1 wherein the property is a residential property, a commercial property, or any such valuable asset such as an air plane, a ship, a boat, a car, a collectible, a restaurant, a manufacture facility, a diamond or a jewelry, a precious metal and a rare earth metal, etc.

3. The method of claim 1 wherein the seller is a party who sells a call option and/or buys a put option on seller's property, may further intent to sell the underline property according to the terms defined by the call option and/or put option; a seller is a person, an organization, an investor, a company, or a speculator, etc

4. The method of claim 1 wherein the buyer is a party who buys a call option and/or sells a put option on seller's property, may further intent to buy the underline property according to the terms defined by the call option and put option; a seller is a person, an organization, an investor, a company, or a speculator, etc

5. The method of claim 1 wherein the auction event is carried out on an auction website hosted on a computer server that equipped with storage hard driver, processor, memory and all peripherals.

6. The method of claim 1 wherein the auction event can be held also offline by a party who has a phone, a fax machine, a writing apparatus and the capability to communicate a buyer and a seller to accomplish an auction.

7. The method of claim 1 wherein the call option prices (COPs) and put option prices (POPs) in the series of call options, series of put options and series of spread options are calculated by using one or more of the following: 1) estimated current home value, 2) strike price, 3) time between auction ending date to the future selling date, 4) estimated annual price change rate, and 5) optionally the subject property price volatility based on historic prices.

8. The method of claim 1 wherein the seller sells a property by selling only a call option; or by buying only a put option; or by the combination of the two in a spread option auction.

9. The method of claim 1 wherein the buyer buys a property by buying only a call option; or by selling only a put option; or by the combination of the two in a spread option auction.

10. The method of claim 1 wherein the seller may set a reserve call option level in a call option auction, and/or set a reserve put option level in a put option auction, and/or set a reserve call/put option levels in a spread option auction such that auction may be declared as unsuccessful in the event reserve is not met, therefore buyer and seller do not enter option agreement event if bids are received in the auction process.

11. The method of claim 1 wherein an outbid function is implemented so that a buyer who is outbid by another buyer is notified in order for the buyer to bid again with a more competitive bidding level. Outbid function is utilized again and again until the auction ending time.

12. The method of claim 1 wherein the seller can sell a call option to one buyer, and buy a put option from a different buyer for seller's underline property; the buyer can buy a call option from one seller, and can sell a put option to a different seller.

13. The method of claim 1 wherein the seller can fix a future selling price of the property and auction only a call option right; and/or the seller can fix a future selling price of the property and auction only a put option obligation; and the combination of auctioning a call option right and auctioning a put option obligation for the amount of delta option price (COP-POP) in exchange for buyer's right to buy at a strike price and obligation to buy at a strike price.

14. The method of claim 1 wherein the seller can fix a call option price and/or a put option price, and or the delta option price (COP-POP) and auction only the highest strike price the buyer has the right to buy, and the highest strike price the buyer is obligated to buy

15. A method and a process to enable a property's auction winning buyer to trade call option and put option won in an auction event by selling the call option right to a new property buyer and by selling the put option obligation to a new property buyer, comprising of steps
15.1. Purchasing a call option in exchange of a call option right to buy a property in accordance to the method of claim 1
15.2. Selling a put option in exchange of a put option obligation to buy a property in accordance to the method of claim 1
15.3. Transacting a spread option comprising of a call option and a put option in exchange of a call option right to buy a property and a put option obligation to buy a property in accordance to the method of claim 1
15.4. Auction wining buyer listing the won call option right for sale by auction or by regular sales channel and sell the call option right to a new property buyer; auction winning buyer receives a payment from the new property buyer in exchange of re-assigning the right to the new property buyer to buy the underline property according to the call option agreement.
15.5. Auction wining buyer listing the won put option obligation for sale by auction or by regular sales channel and sell the put option obligation to a new property buyer; auction winning buyer pays the new property buyer in exchange of re-assigning to the new property buyer the obligation to buy the underline property according to the put option agreement.
15.6. Auction wining buyer listing the won spread option or sale by auction or by regular sales channel and sell the call option right and put option obligation to a new property buyer; auction winning buyer receives a payment from the new property buyer in exchange of re-assigning to the new property buyer the right to buy and obligation to buy the underline property according to the spread option agreement.
15.7. Auction winning buyer and new property buyer execute a call option right transfer agreement according to the call option agreement, and/or execute a put option obligation transfer agreement, and/or execute the composite agreement of the two according to the spread option agreement.

16. The method of claim 15 wherein a call option right and put option obligation are traded again and again prior to its expiration.

17. The method of claim 15 wherein the new property buyer is the original property seller, a real estate investor, individual or group or corporation.

18. The method of claim 15 wherein the method and process enables individuals, groups and corporations to participate in real estate investment to make profits by correctly speculating the real estate property price movement and movement direction, and by executing a call, and/or a put, and/or a spread option agreement.

19. The method of claim 15 wherein the method and process allows a real estate investment entity to manage a plurality of call option rights and a plurality of put option obligations and to make profits by correctly speculating the real estate market movement and movement direction and through a business of buying and selling the option rights and obligations.

20. The method of claim 15 wherein the process is conducted in a format in addition to web-based auction format, such as auction in a physical location, and auction by using phone and fax, and other means to engage transactions of the rights and obligations from one party to another party.
